(19) United States
(12) Patent Application Publication
(10) Pub. No.: US 2011/0233195 A1
(43) Pub. Date: Sep. 29, 2011

(54) RADIATOR FOR A HOUSEHOLD APPLIANCE

(75) Inventors: Miguel Angel Buñuel Magdalena, Zaragoza (ES); Francisco Javier Ester Sola, Zaragoza (ES); Jose-Ramon Garcia Jimenez, Zaragoza (ES); Damaso Martin Gomez, Zaragoza (ES); José Ignacio Peña Torre, Zaragoza (ES); Daniel Sola Martinez, Zaragoza (ES)

(73) Assignee: BSH BOSCH UND SIEMENS HAUSGERATE GmbH, Munich (DE)

(21) Appl. No.: 13/132,645

(22) PCT Filed: Dec. 7, 2009
(86) PCT No.: PCT/EP2009/066470

§ 371 Date: Jun. 3, 2011

(30) Foreign Application Priority Data
Dec. 19, 2008 (ES) P200803713

(51) Int. Cl. H05B 6/12

(52) U.S. Cl. 219/620; 29/592

(57) ABSTRACT

A light-permeable hot plate includes at least one cavity which is filled with illuminant. The illuminant in the cavity can be excited to illuminate by an electromagnetic excitation field. The hot plate may be part of a household appliance which includes an induction hob with a cooking zone, with the hot plate being assigned to the at least one cooking zone for heating a cooking vessel placed on the cooking zone.

The invention relates to a radiator for a household appliance, in particular for an oven, a household appliance with at least one radiator and a method for the manufacture of a radiator.

For the baking of foodstuffs by means of infrared (IR) radiation, resistance heating elements are known, which are arranged in a cooking compartment of an oven.

The object of the invention is to make available a particularly precise, flexible and efficient possibility for the generation of radiation in household appliances, in particular for baking.

This object is achieved according to the features of the independent claims. Developments of the invention are evident from the dependent claims.

The radiator for a household appliance has at least one cavity, which is filled with at least one illuminating means. The at least one illuminating means can be excited by means of an electromagnetic excitation field, in particular a magnetic alternate field, for the emission of radiation, in particular for the emission of infrared radiation.

The radiator is in particular embodied as an infrared radiator and/or as a light or luminescence radiator. The illuminating means can for example be an infrared illuminating means. Accordingly, the radiation can comprise an infrared radiation.

The radiator has the advantages that the illuminating means is excited instantly, and the illuminating means can thus rapidly emit heat. In the same way, heat emission is terminated immediately upon switching-off of the excitation field. A heat input can consequently be very precisely and directly controlled. In addition the excitation of the illuminating means in the cavity is particularly reliable and efficient.

Different, in particular simply implementable variations are also possible for the cavity. This calls for a correspondingly high degree of design flexibility.

In one embodiment, a radiator with at least one cavity is at least partially, in particular completely, surrounded by a glass-like body. The glass-like body can be a body made of glass, glass ceramic or a combination of the two. As a result of its simple integratability, the radiator is flexibly applicable. Furthermore, the body surrounding the cavity can comprise any light-permeable, in particular infrared-permeable, and preferably high temperature-resistant material, e.g. a transparent ceramic or a plastic. The body can be manufactured from non-opaque material.

In order to save weight and structural height while at the same time having large-area heat radiation, a radiator with a plate-shaped glass-like body can be employed. In particular the at least one cavity can be embodied in an extensive form.

There is also one embodiment in which the cavity is embodied in electrodeless form.

In this case, the at least one IR-illuminating means present in the cavity can be excited by means of an external excitation field, in a manner similar to the principle of operation of a nullode. Such an exemplary embodiment is particularly durable and reliable.

The radiator can have at least one excitation means for generation of the electromagnetic excitation field, e.g. a high-frequency (HF) generator.

For the simple and low-cost excitation of the illuminating means, in particular, if no electrode is present in at least one cavity, the electromagnetic excitation field can preferably be generated by means of at least one coil. To this extent the excitation means can have at least one coil.

If no or no sufficiently powerful external excitation field can be generated or an external excitation means is too costly or of too great a volume, at least one electrode, preferably two or more electrodes can be introduced into at least one cavity filled with illuminating means, for generation of the electromagnetic excitation fields.

All suitable illuminating means, in particular infrared illuminating means can be used as the illuminating means, which can be excited subject to an electromagnetic excitation field for illumination e.g. in the infrared range, in particular in the near infrared range (NIR), and specifically individually or in a combination or mixture.

In particular the illuminating means can have a noble gas or a combination of noble gases. This is advantageous, as noble gases are non-toxic and inert. Other illuminating means are however conceivable in principle, e.g. mercury or mercury compounds, halogens, carbon dioxide or fixed illuminating means (e.g. phosphorous-based illuminating means).

For particularly effective heating of foodstuffs, a radiator can be employed, in which the radiation emitted has its maximum level at a wavelength which permits particularly good penetration for foodstuffs. For example the radiation can have a maximum in the region of around 1.3 μm.

Overall a radiator can be employed, which radiates a majority (e.g. more than 50%) of its energy e.g. in the infrared range, in particular in the near infrared range.

It is also possible that the illuminating means emits part of its radiation energy in the form of visible light, so that the heat radiation surface is visually easy for a user to recognize and if appropriate to avoid. This improves operating safety.

To achieve the object a household appliance is provided, which has at least one radiator as described.

The household appliance preferably has a cooking compartment (e.g. a cooker, an oven or a microwave oven), where at least one radiator is arranged on or in at least one wall of the cooking compartment. For baking in particular the radiator can thereby heat foodstuffs present in the cooking compartment, specifically alone or together with conventionally present heating means, such as a bottom heating element, a top heating element, a circulating air heater, a microwave generation unit, etc.

The household appliance can also have a hob with a cooking zone, e.g. an individual hob or a cooker, where at least one radiator of at least one cooking zone can be used for the heating of a cooking vessel located on a cooking zone.

For example the cavity can be arranged in or on the hot plate of the hob and can also radiate visible light on safety grounds or for the information of a user.

For example a cooking zone can be defined by the cavity.

Furthermore, in order to achieve the object, a method for the manufacture of a radiator as described herein is specified, comprising the steps:

(a) evacuation of the cavity, preferably by means of a vacuum pump to a pressure range between 10⁻¹ atm and 10⁻⁵ atm;

(b) filling of the cavity with at least one IR illuminating means; and

(c) (hermetic) sealing of the cavity.

It is also possible that the cavity is previously introduced into an in particular glass-like body. This can for example take place by means of laser processing with a focal point within the body, as in this way a jointing procedure with the consequent jointing surfaces can be avoided.

Furthermore for simple processing of the body a method can be employed which has the step of the introduction of at least one recess in an underside of the body and a subsequent covering of the free opening of the recess with a cover, in particular by means of bonding the open surface with a glass plate.

Exemplary embodiments of the invention are represented and illustrated below on the basis of the drawings. For greater clarity here, elements which are the same or have a similar effect can be provided with the same reference characters.

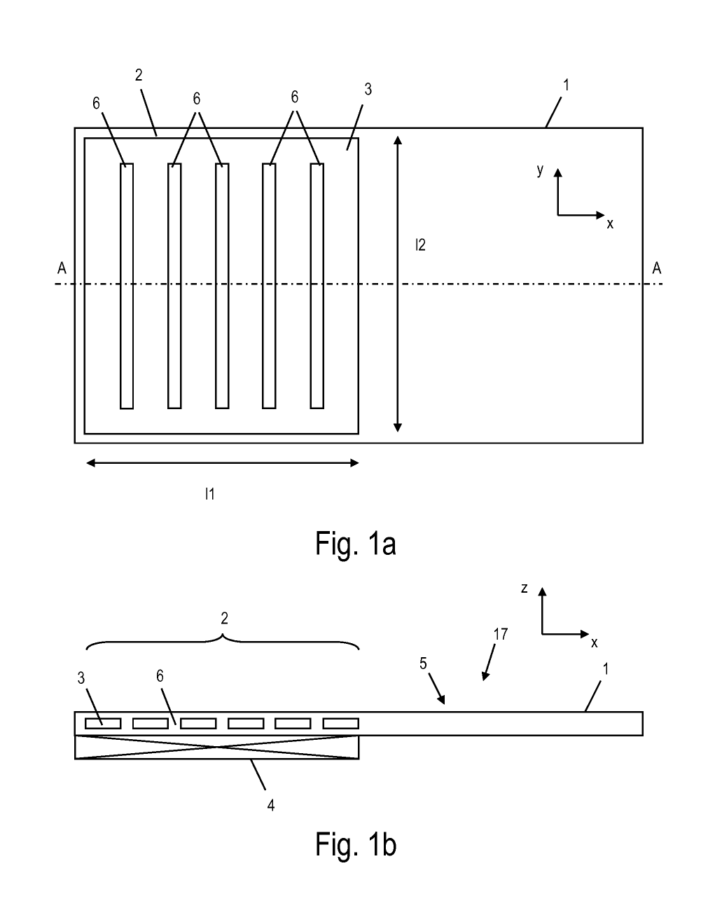

FIG. 1a shows, in a top view seen from above, a glass ceramic plate of a radiator,

FIG. 1b shows, as a cutaway representation seen from the side, a radiator with the glass ceramic plate from FIG. 1a and an additional excitation field source

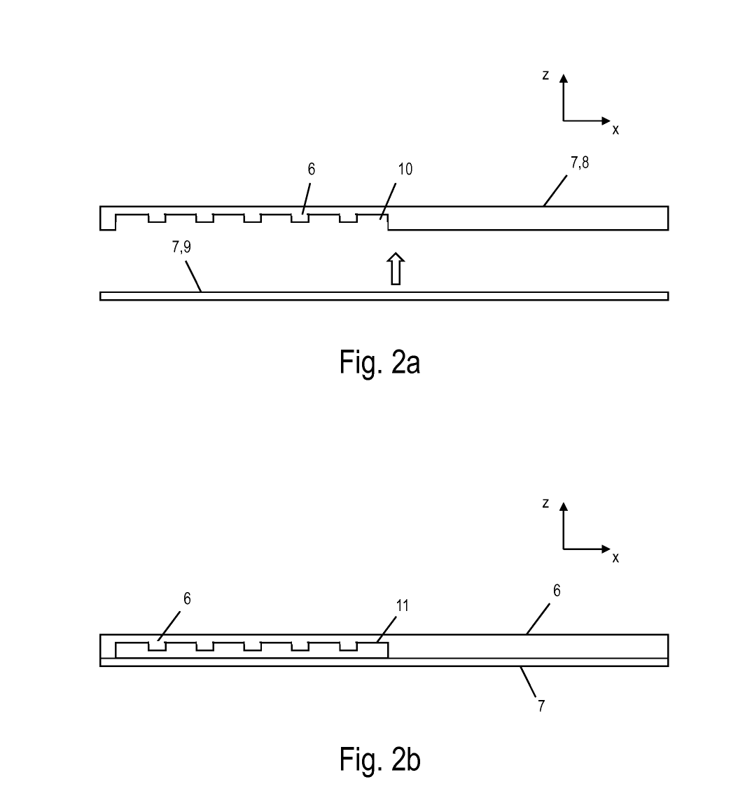

FIG. 2a shows, as a cutaway representation seen from the side a glass ceramic plate manufactured according to a different method in a first manufacturing step;

FIG. 2b shows, as a cutaway representation seen from the side, the glass ceramic plate from FIG. 2a in a second manufacturing step;

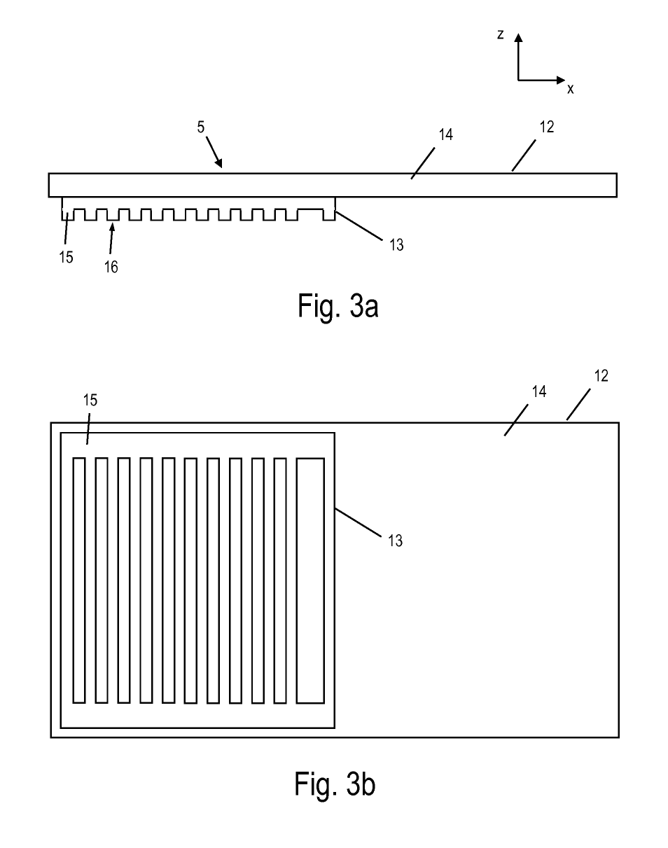

FIG. 3a shows, as a cutaway representation seen from the side, a glass ceramic plate manufactured according ton a further method;

FIG. 3b shows, in top view seen from above, the glass ceramic plate from FIG. 3a.

The infrared radiator described below by way of example may take the form of any radiator, in particular any type of light or luminescence radiator.

FIG. 1a shows, in a top view seen from above, an IR transparent glass ceramic plate 1 of a radiator, in particular of an infrared or heat radiator, into which a rectangular heat radiation zone 2 with length I1 and width I2 is introduced.

FIG. 1b shows, as a cutaway representation seen from the side, the heat radiator 17 with the glass ceramic plate 1 along the line of intersection A-A from FIG. 1a. The heat radiation zone 2 is defined by means of a continuous cavity 3 completely surrounded by the material of the glass ceramic plate 1, which functions as an infrared radiation region.

To this end the cavity 3 is filled with at least one infrared illuminating means (not shown), which is excited in an electromagnetic excitation field for the emission of heat radiation.

For the generation of the excitation field located underneath the cavity 3 is a coil 4 which generates a magnetic alternate field which is directed upwards (in z direction) into the cavity 3. By means of the magnetic alternate field the at least one infrared illuminating means, which is here provided in the form of one or more noble gases, is ionized and upon recombination emits, among other things, IR light of a wavelength in the region of 1.3 μm, which penetrates at least partially through the glass ceramic plate 1 on its top side 5. The cavity 3 can function in a similar manner to a nullode light tube. On the top side 5, the heat radiation can be transferred to a cooking vessel placed on the heat radiation zone 2. For effective heat radiation to the top side 5, an IR reflector (not shown) can be present underneath the cavity 3, which is largely permeable for the excitation field. To improve stability, in particular for protection against breakage of the cavity wall, the cavity 3 has parallel and equidistantly arranged ribs 6.

In order to indicate the heat radiation zone 2 for the benefit of a user, the infrared illuminating means also emits light in the visible range, so that the heat radiation zone 2 lights up in a colored or identifiable manner. The wavelength of the radiated visible and/or infrared light can in each case be set by the type of the illuminating means, a pressure in the cavity and/or by means of an excitation frequency.

To manufacture the glass ceramic plate 1 a glass ceramic plate provided without the cavity 3 is initially processed with a laser processing method, in which the laser is focused in the glass ceramic plate and there creates the cavity 3. A through-hole (not shown) can further be created between the cavity 3 and the exterior. Via the through-hole, the cavity can be evacuated with the aid of a vacuum pump through the creation of a negative pressure in a range of 10⁻¹ atm and 10⁻⁵ atm. An infrared illuminating means, e.g. a noble gas or a noble gas mixture, can then be admitted into the cavity 3 via this through-hole, until a comparatively low negative pressure obtains in the cavity 3. The through-hole is thereafter hermetically sealed, for example by means of a vitreous glass bond.

FIG. 2a shows, as a cutaway representation seen from the side, a glass ceramic plate 7 manufactured with a different method in a first manufacturing step. In this manufacturing step the glass ceramic plate 7 is initially divided into an upper part 8 and a lower, thin cover plate 9. A rectangular recess 10 is introduced in the side of the upper part 8 lying opposite the cover plate 9 by means of a surface-abrasion processing method, e.g. by means of laser ablation, sandblasting processing, water jet processing, micromachining, etc.

After introduction of the recess 10, the cover plate 9, as shown in FIG. 2b, is mounted on the underside of the upper part 8 in the direction indicated by the arrow in FIG. 2a, in a following manufacturing step, and permanently connected to this, so that a negative pressure-tight cavity 11 is formed with the recesses 10. The upper part 8 and the cover plate 9 thus form the glass ceramic plate 7.

FIG. 3a shows, as a cutaway representation seen from the side, a glass ceramic plate 12 manufactured according to a further method, from the underside of which a separately manufactured glass ceramic element 13 projects, which is connected (in particular inseparably) to a solid upper plate part 14 and which has a cavity 15 filled with IR illumination means.

FIG. 3b shows, in a top view seen from above, the glass ceramic plate 12 with the glass ceramic element 13 from FIG. 3a. The glass ceramic element 13 and an upper plate part 14 form for example the glass ceramic plate 12. In contrast to the forms of the cavities 3 or 11 respectively shown in FIG. 1 and in FIG. 2, a lower external contour 16 of the glass ceramic element 13 and thus of the cavity 15 is embodied in stepped form, and thereby creates a similarly visible pattern to cavities 3 or 11 respectively on the top side 5 for the benefit of a user.

The exemplary embodiments shown have advantages including the fact that heat can be efficiently generated at the heat radiation zone (see e.g. reference character 2 in FIG. 1b) and swiftly switched on or off.

As in addition the cavity functioning as an infrared radiation area can be integrated into the glass ceramic plate, and in particular can be completely realized in glass ceramic, the glass ceramic plate is simple and flexible to use. The form of the cavity is also variable and thus permits a high degree of design flexibility.

The present invention is of course not limited to the exemplary embodiments shown. Thus, mercury, phosphorous or other non-gaseous materials can also be used as infrared illuminating means. In addition the infrared illuminating means is not restricted to noble gases as illuminating gases. For example halogens, halogen mixtures or carbon dioxide can also be used.

As an alternative or an addition to the excitation of the infrared illuminating means by an irradiation of an electromagnetic field, in particular of a magnetic alternate field, electrodes can also be introduced into the cavity, in order to generate the excitation field. This type of embodiment is dependent upon the location and strength of an external excitation source.

It is furthermore possible to provide one or more cavities filled with infrared illumination means per cooking zone or hob. Electrodeless cavities and cavities fitted with electrodes can also be employed individually or in combination for a hot plate or cooking zone.

Instead of glass ceramic, any other IR-permeable and preferably heat-resistant material can also be used, such as glass, plastic or ceramic.

Furthermore, the form of the at least one cavity is not limited to an open, a closed or an angular basic form. In particular the at least one cavity can also be embodied in oval or annular form. One or a multiplicity of cavities can also be spherical, droplet-like or stroke-like in form.

### LIST OF REFERENCE CHARACTERS

1 Glass ceramic plate

2 Heat radiation zone

3 Cavity

4 Inductor coil

5 Top side of the glass ceramic plate

6 Rib

7 Glass ceramic plate

8 Upper part of the hot plate

9 Lower cover plate

10 Recess

11 Cavity

12 Glass ceramic plate

13 Glass ceramic element

14 Upper plate part

15 Cavity

16 External contour

17 Heat radiator

I1 Length of heat radiation zone

I2 Width of heat radiation zone

1-16. (canceled)

17. A radiator for a household appliance, said radiator comprising at least one cavity filled with at least one illuminant which is excitable by an electromagnetic excitation field for emission of radiation.

18. The radiator of claim 17, wherein the illuminant comprises an infrared illuminating member emitting an infrared radiation.

19. The radiator of claim 17, further comprising a glass-like body at least partially surrounding the at least one cavity.

20. The radiator of claim 19, wherein the glass-like body completely surrounds the at least one cavity.

21. The radiator of claim 19, wherein the glass-like body is plate-shaped.

22. The radiator of claim 17, wherein the at least one cavity is embodied in a planar manner.

23. The radiator of claim 17, wherein the at least one cavity is configured in the absence of an electrode introduced therein.

24. The radiator of claim 17, further comprising at least one excitation source for generation of the electromagnetic excitation field.

25. The radiator of claim 24, wherein the excitation source includes at least one coil to generate electromagnetic excitation field.

26. The radiator of claim 17, further comprising at least one electrode introduced into the at least one cavity filled with illuminant for generation of the electromagnetic excitation field.

27. The radiator of claim 17, wherein the at least one illuminant comprises a noble gas.

28. The radiator of claim 17, wherein the radiation emitted is at a maximum at a wavelength in the area of about 1.3 μm.

29. A household appliance, comprising at least one radiator having at least one cavity filled with at least one illuminant which is excitable by an electromagnetic excitation field for emission of radiation.

30. The household appliance of claim 29, further comprising a cooking compartment, said at least one radiator being arranged on at least one wall of the cooking compartment.

31. The household appliance of claim 29, further comprising a hob with a cooking zone, said at least one radiator being assigned to the at least one cooking zone for heating a cooking vessel placed on the cooking zone.

32. The household appliance of claim 31, wherein the illuminant emits visible light, with radiated visible light being visible through a surface of the hob.

33. A method for the manufacture of a radiator, comprising the steps of:
evacuating a cavity of the radiator;
filling the cavity with at least one illuminant; and
sealing the cavity.
